(19) United States
(12) Patent Application Publication
(10) Pub. No.: US 2016/0243005 A1
(43) Pub. Date: Aug. 25, 2016

(54) Wrist teething chewing apparatus with removable interchangeable chewing devices

(71) Applicant: Verlean Paicely, Jacksonville, FL (US)

(72) Inventor: Verlean Paicely, Jacksonville, FL (US)

(21) Appl. No.: 14/626,907

(22) Filed: Feb. 19, 2015

(51) Int. Cl. A61J 17/00; A61J 17/02

(52) U.S. Cl. CPC A61J 17/007; A61J 17/02

(57) ABSTRACT

A wrist teether with interchangeable and removable teething toys. The invention is configured to be secured to a child's wrist. The toy(s) are secured by a loop on the bottom of the toy that is then attached to a wrist band which is then secured to the child.

### BRIEF SUMMARY OF THE PRESENT INVENTION

The present invention comprises a wrist teething apparatus device with removable or interchangeable teething toys. The invention is configured to be mounted to a child's wrist with the ability for the child to mouth, chew, play and interchange different toys to the wrist band.

The invention includes a interchangeable toy(s) that attach to the band as this is controlled by the caregiver of the child.

A loop is attached to the bottom of the toy(s) that allows for the toy to be attached to the band. The band is secured to the child's wrist.

### BRIEF DESCRIPTION OF THE SEVERAL VIES OF THE DRAWINGS

FIG. 1 is the right side view of the device

FIG. 2 is the bottom view of toy with loop attached to toy

FIG. 3 is the left side view of the device

FIG. 4 is the side view of the bottom of loop attached to toy

FIG. 5 is the band that attaches to toy and baby's wrist

FIG. 6 is the bottom view of band through bottom of toy

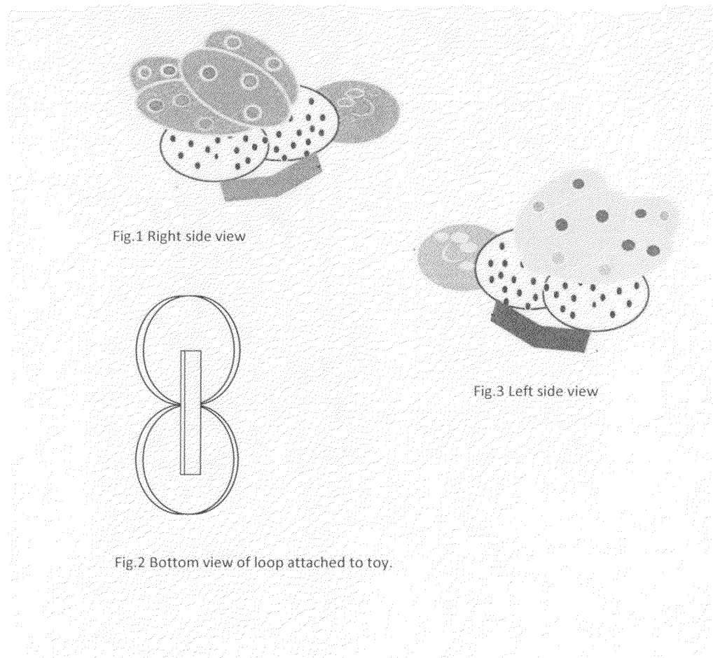

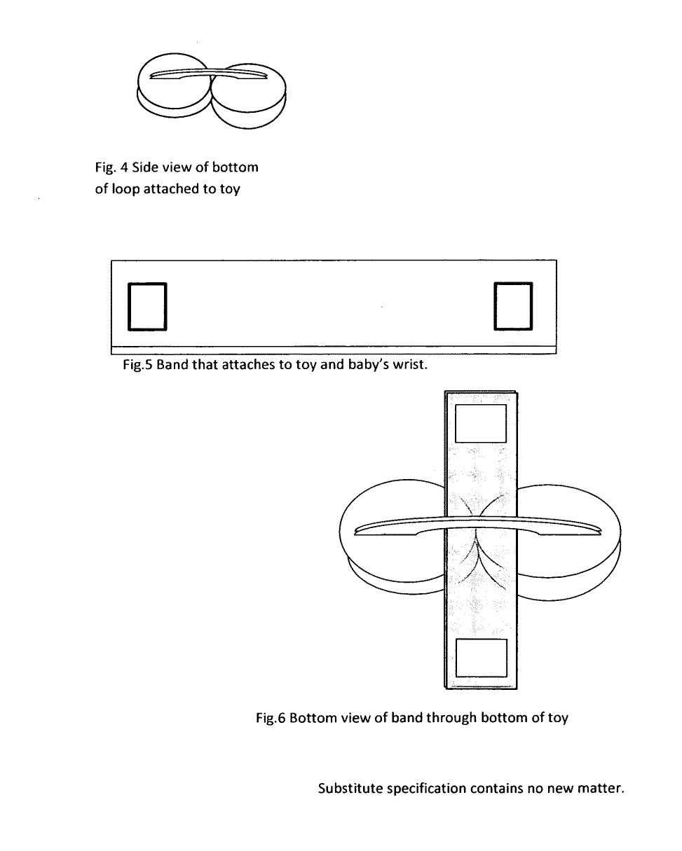

Having described in my invention, I claim:

1. The band secures to a child's wrist with the ability to mount a chewing apparatus
a. The device is comprised of a fastener that secures to the child's wrist.
b. The band allows for toy(s) to attach and or mount to the band.

2. Chewing apparatuses comprise of a loop attached to the bottom of the toy(s) that secure to the band.
a. The chewing apparatus contain a loop that band slides through to allow for the toy(s) to be mounted to the band.
b. Chewing apparatuses vary in color, shape, material and sizes.

3. Chewing apparatus or toy is a device that is used for soothing gums
a. The chewing toy is secured to the loop and is used to for soothing sore itchy gums while the child is teething.
